(19) United States
(12) Patent Application Publication
(10) Pub. No.: US 2024/0008452 A1
(43) Pub. Date: Jan. 11, 2024

(54) COMBINATION ROPE TOY AND BOX HANDLE

(71) Applicant: Lewis Hamowy, New York, NY (US)

(72) Inventor: Lewis Hamowy, New York, NY (US)

(21) Appl. No.: 18/349,742

(22) Filed: Jul. 10, 2023

Related U.S. Application Data
(60) Provisional application No. 63/368,102, filed on Jul. 11, 2022.

(51) Int. Cl. A01K 15/02

(52) U.S. Cl. CPC A01K 15/026

(57) ABSTRACT

A pet accessory box foldable from a unitary flat blank, wherein the box forms a reinforced handle slot that enables a toy rope to be used as a handle for the box, whereby the toy rope can later be removed from the handle slot so it can be used as a standalone toy.

### CROSS-REFERENCE TO RELATED APPLICATION

This application claims the benefit of priority of U.S. provisional application No. 63/368,102, filed 11 Jul. 2022, the contents of which are herein incorporated by reference.

### BACKGROUND OF THE INVENTION

The present invention relates to pet supplies and, more particularly, a combination pet toy rope and box handle.

As our landfills fill up, reduction of waste can play an important part in cutting back on the amount of trash that is generated and later piled into a landfill.

One long-lasting pet toy is the pet toy rope. The pet toy rope typically has opposing knots so that a dog or other pet can engage another animal or person in a tug of war. Pet toy rope can be made of sustainable materials, such as hemp or other recyclable, non-toxic, and biodegradable material that are generally pro-environment.

Separately, pet waste bags are almost always bought by the box, as are some other pet accessories. Such boxes can be made of sustainable material, but if the box has a handle, it is plastic or at least an additional mass of material that needed to come from a resource.

As can be seen, there is a need for a box for pet accessories that is engineered so that a pet toy rope can be used as a handle to the box and then later used as a standalone pet toy, thereby creating a dual use item that reduces waste.

### SUMMARY OF THE INVENTION

The inventive concept includes the attachment of the toy rope to the box of pet accessories, whereby the handle can subsequently be wholly removed and used as a pet toy rope.

By designing a special box with a novel handle attachment that incorporates the rope toy as the box handle, a dual use item is created, whereby the rope toy is engineered with more benefit and wider appeal to consumers, cutting down on packaging material, and reducing waste and as such is better for the environment.

A special die cut design of box allows for attaching an actual rope pet toy in the right dimensions to the box so that it can be used as a functional box handle, and then later removed and used as a pet toy.

The dual use pet toy rope gives the customer added value as a dual use product. The box is engineered so that a pet toy rope can be incorporated into the design of the box for functional use as a handle and later to be taken out for being played with by the pet. In sum, the pet toy rope operates as an actual functional handle of the specially designed box, providing perfect harmony of form and function and value.

In the absence of the present invention, one could never get these two products together—the packaging does not work this way in the prior art. Now, through the present invention, the purchaser has two different products in one purchase, eliminating extra packaging as the rope toy itself is the handle of this package.

In one aspect of the present invention, a box formed from a unitary blank, wherein the box enables a rope toy to act as a handle thereto, the box includes the following a first side panel, a front panel, a second side panel, and a rear panel sequentially joined along fold lines; a first top side panel foldably connected to an upper edge of the first side panel; a front top panel foldably connected to an upper edge of the front panel; a rear top panel foldably connected to an upper edge of the rear panel; a second top aide panel foldably connected to an upper edge of the second side panel; the front top panel having a handle slot centrally disposed therein; the top side panels each providing a half slot that align, when the box is formed, with opposing halves, respectively, of the handle slot; and two openings in the rear top panel that are spaced apart by a barrier portion of the rear top panel, wherein the two openings align with the opposing ends of the handle slot, and wherein the barrier portion aligns with a midportion of the handle slot.

In another aspect of the present invention, the box further includes wherein the handle slot is elongated; further including a rope having two end portions connected by a midportion, wherein the midportion is dimensioned and shaped to slide through the handle slot and the two end portions are not slidable through the handle slot, wherein the two end portions are knots in the rope, wherein the two openings constrain said midportion when it protrudes through the handle slot from a compartment of the box, wherein the each opening of the two openings is a slot that communicates with an unconnected edge of the rear top panel, and wherein the each opening of the slots of the two openings are oriented in a direction orthogonal to the handle slot when the unitary blank is in a flat condition.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention.

FIG. 2 is an exploded perspective view of an exemplary embodiment of the present invention, illustrating a box in an open condition.

FIG. 3 is a section view of an exemplary embodiment of the present invention, taken along line 3-3 in FIG. 1.

FIG. 4 is a top plan view of an exemplary embodiment of the present invention, illustrating the flat condition of the unitary blank.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

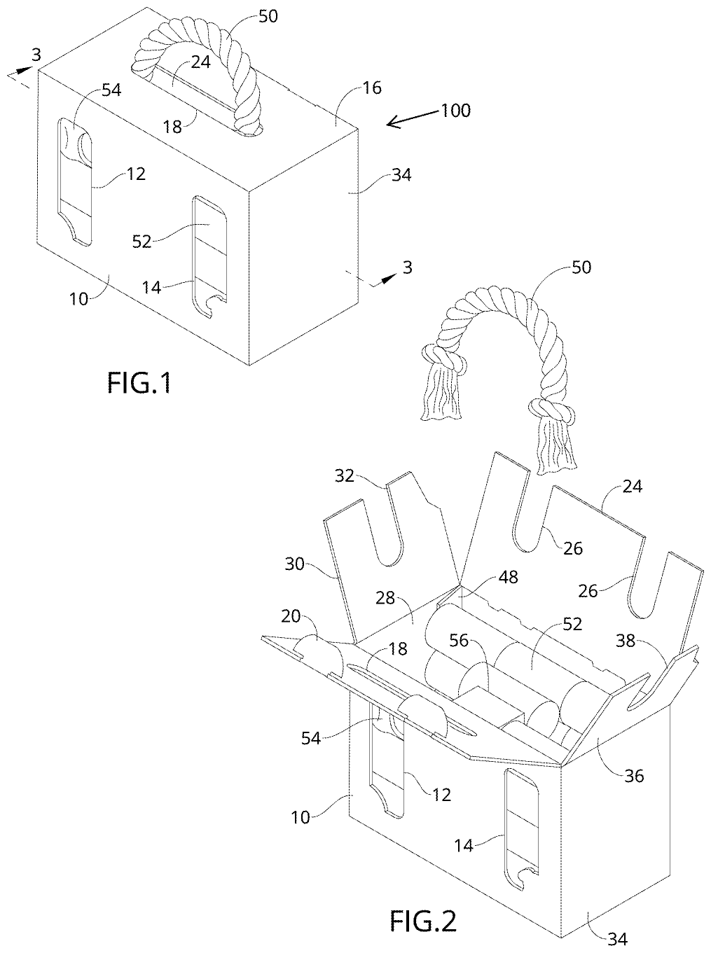

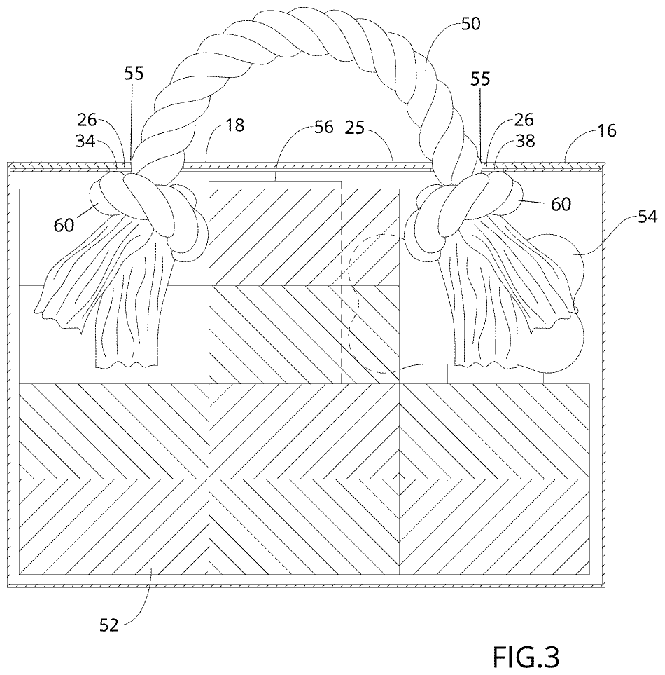

Referring now to FIGS. 1 through 4, the present invention may include a box 100 foldable from a unitary flat blank 200, wherein the box 100 forms a reinforced handle slot 18 that enables a rope toy 50 to be used as a handle for the box 100 and later removed from the handle slot 18 so it can be used as a standalone toy.

The unitary flat blank 200 may be die cut from a sustainable material so that the following panels are sequentially coupled by fold lines for folding the blank 200 to form a rectangular body of the box 100: a first side panel 28, a front panel 10, a second side panel 34, and a rear panel 22. The front panel 10 may provide first and second view slots 12, 14 for viewing a portion of the contents of the box 100.

The side panels 28, 34 may include opposing end fold lines. From one end fold line, respectively, first side top panels 30, 36 is foldably coupled, while from the opposing end fold line a side bottom panel 46, 44 are, respectively, foldably coupled.

Along the opposing folding lines of the front panel 10, a front top panel 16 and a front bottom panel 40, respectively, may be foldably joined. Likewise, along the opposing folding lines of the rear panel 22, a rear top panel 24 and a rear bottom panel 42, respectively, may be joined. Along a fold line of the other edge (opposite the second side panel 34) of the rear panel 22, a rear panel tab 48 may be provided for tucking into the first side panel 28 when the box 100 is formed.

One or more front top tabs 20 may be foldably connected to an edge of the front top panel 16 for engaging an opposing edge of the rear panel 22 when forming the box 100. The top panel 16 may provide an elongated handle slot 18. The elongated handle slot 18 may be centrally disposed in the top panel 16. The elongated handle slot 18 may have rounded ends.

Each side top panel 30, 36 provide an elongated half handle slot 32, 38. In the folded condition, the half handle slots 32, 38 reinforce the elongated handle slot. Specifically, in the folded condition each half handle slot 32, 38 aligns with a respective half of the handle slot 18, thereby providing a two-ply top panel of the box 100.

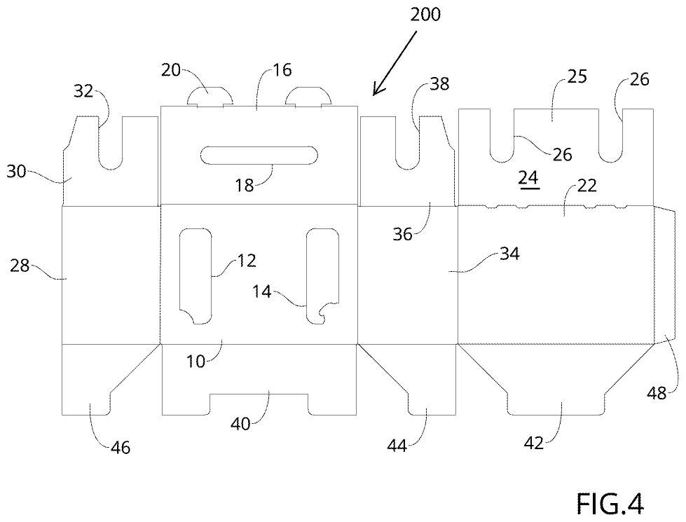

The rear top panel 24 provides two spaced apart openings 26. The two openings 26 are spaced apart by a barrier portion 25 of the rear top panel 24. Thus, in the folded condition, the two openings 26 align with the two opposing ends of the handle slot 18, but not with the midportion of the handle slot 18. The openings 26 may be hole but may be slots that communicated with the unconnected edge of the rear top panel 24, as illustrated in FIG. 4. As a result, in the folded condition, the handle slot 18 has two spaced apart apertures 55 that communicate to the compartment defined by the box 100 and separated by the barrier portion 25 that blocks the midportion of the handle slot 18.

Accordingly, in a closed condition the rope toy 50 acts as the handle of the box 100 when the body of the rope toy 50 protrudes outside the box 100 while the two opposing knots 60 of the rope toy 50 are in the compartment and prevented by the two spaced apart apertures 55, respectively, of the handle slot 18 from being removed from the compartment. In an open condition, the rope toy 50 may be slid from the handle slot 18 in a direction away from the outer surface of the box 100.

The blank 200 needs to be engineered and die cut specifically to incorporate the rope toy 50 as an actual handle to be functional as a unique handle-toy dual-use product. The rope toy 50 and knots 60 itself needs to be sized correctly to fit the specifically sized die-cut handle slot apertures 55.

Together, the rope toy 50 and the box 100 act as one functional item for sale individually—as opposed to the rope toy by itself and separately a box of pet waste bags—rather, both are engineered together. Thereby, the present invention is functionally two products in one—a dual product—whereby a complete package includes the box 100 having a functional handle for dual usage as a pet toy, cutting down on packaging material and creating a one-of-a-kind aesthetically pleasing product that added value and is environmentally greener.

The box 100 defines a compartment that can be filled with waste bags 52, one or more bag dispensers 54, a paper insert 56 or other accessories.

A method of making the present invention may include the following. The flat blank 200 needs to be designed and engineered to have special grooves and fold lines to incorporate the rope toy 50 and have it hold up correctly as the actual handle of the box 100. The rope toy 50 needs to be engineered to the correct thickness and length to fit the design of the box 100.

The die cut blank 50 when folded along its fold lines defines the box 100 with an elongated handle opening 18, from which a middle portion of the rope toy 50 protrudes to act as a handle.

Eyelets, washers, and/or other forms of reinforcements may be used to connect the rope toy 50 to the box 100, making it sturdier, but one embodiment may be engineered without adding extra reinforcement elements.

Rubber or TPR material or any another fabric or woven material for the handle that is safe for a pet and is a type of chew toy for the pet as the dual-use handle may be incorporated into the present invention.

A method of using the present invention may include the following. The present invention may be used to create a product that has a pet toy that is also a functioning handle for the box and is removable from the box for play, thereby eliminating excess packaging and creating a smaller carbon footprint. The removable dual-use handle is a unique aesthetic that gives the consumer added value and creates fun and exercise for the pet.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A box formed from a unitary blank, wherein the box enables a rope toy to act as a handle thereto, the box comprising:
a first side panel, a front panel, a second side panel, and a rear panel sequentially joined along fold lines;
a first top side panel foldably connected to an upper edge of the first side panel;
a front top panel foldably connected to an upper edge of the front panel;
a rear top panel foldably connected to an upper edge of the rear panel;
a second top aide panel foldably connected to an upper edge of the second side panel;
the front top panel having a handle slot centrally disposed therein;
the top side panels each providing a half slot that align, when the box is formed, with opposing halves, respectively, of the handle slot; and
two openings in the rear top panel that are spaced apart by a barrier portion of the rear top panel, wherein the two openings align with the opposing ends of the handle slot, and wherein the barrier portion aligns with a midportion of the handle slot.

2. The box of claim 1, wherein the handle slot is elongated.

3. The box of claim 1, further comprising a rope having two end portions connected by a midportion, wherein the midportion is dimensioned and shaped to slide through the handle slot and the two end portions are not slidable through the handle slot.

4. The box of claim 3, wherein the two end portions are knots in the rope.

5. The box of claim 4, wherein the two openings constrain said midportion when it protrudes through the handle slot from a compartment of the box.

6. The box of claim 5, wherein the each opening of the two openings is a slot that communicates with an unconnected edge of the rear top panel.

7. The box of claim 6, wherein the each opening of the slots of the two openings are oriented in a direction orthogonal to the handle slot when the unitary blank is in a flat condition.
